(19) United States
(12) Patent Application Publication
(10) Pub. No.: US 2022/0004033 A1
(43) Pub. Date: Jan. 6, 2022

(54) Laser Cutting of Laminated Liquid Crystal Films for Use in Lenses for Training Eyewear

(71) Applicant: Instinct Performance LLC, Oklahoma City, OK (US)

(72) Inventor: David Fishbaine, Minnetonka, MN (US)

(73) Assignee: Instinct Performance LLC, Oklahoma City, OK (US)

(21) Appl. No.: 16/917,957

(22) Filed: Jul. 1, 2020

(51) Int. Cl. G02F 1/13; G02F 1/16753; G02F 1/1333; B23K 26/06

(52) U.S. Cl. CPC G02F 1/1303; G02F 1/16753; B23K 2103/42; B23K 26/0626; G02F 1/133305

(57) ABSTRACT

Laminated liquid crystal films may be processed using a laser beam to form tear lines. Tear lines create a weak line in a liquid crystal film along which a portion of a PET layer may be torn from the whole PET layer. Tear lines are made by the precise volumetric removal of PET material from a portion of a PET layer by burning away the PET material using the laser beam. The form, extent and depth of penetration of a laser beam into a PET layer may be precisely controlled by adjusting the power and/or scan speed of the laser beam relative to the laminated liquid crystal film on which the PET layer is positioned. In this manner, a desired volume of PET material may be removed from the PET layer.

### CROSS-REFERENCE TO RELATED APPLICATIONS

[None]

### FIELD OF THE INVENTION

The present invention relates to the efficient and accurate cutting of a laminated liquid crystal film used to make lenses for use in training eyewear. Specifically, the present invention relates to the use of a laser to cut and form a shaped lens from a laminated liquid crystal film in order to provide access to one or more electrical contact layers in the laminated liquid crystal film. The invention permits the controlled cutting of one or more tear lines in one or more PET layers in the laminated liquid crystal film to facilitate the removal one or more portions of the one or more PET layers. The invention enables the precise and controlled volumetric removal of PET material from a PET layer of a laminated liquid crystal film for form a tear line to facilitate the removal of a portion of a PET layer to expose the electrical contacts for use.

### BACKGROUND OF THE INVENTION

Laminated liquid crystal films are commonly incorporated into eyewear as elements of lenses for visual training purposes. Such eyewear uses the ability to control the alteration of all or some of the liquid crystal film pixels between a substantially transparent state and a substantially opaque state (or a substantially translucent state). By alternating between a translucent state and an opaque state in a controlled manner and for controlled times, visual demands placed on the person wearing the training eyewear may be increased in a way designed to train the person to process and/or react to visual information better.

Laminated liquid crystal film lenses typically comprise a liquid crystal layer laminated onto one or two transparent layers in which the transparent layers may provide shape, structural support and other benefits to the liquid crystal layer and may be made from a variety of suitable materials, including primarily polyethylene terephthalate (“PET”). The transparent state or opaque state of each pixel in the liquid crystal layer is controlled through connection to electrically conductive layers, such as extremely thin, optically transparent layers of metal(s), which are typically disposed on opposite sides of a liquid crystal layer. External electronics are appropriately connected to each of the electrically conductive layers to apply an electric field across the liquid crystal layer to switch the one or more pixels of the liquid crystal layer between a transparent state and an opaque state. In order to obtain proper electrical connections between the external electronics and the electrically conductive layers, each electrically conductive layer must be at least partially exposed without damaging the electrically conductive layer. At least partially exposing an electrically conductive layer requires removing at least part of one of the protective transparent layers of PET from the assembled laminated liquid crystal film, a process typically performed manually using a razor or other cutting instrument. At the least, manual cutting is time consuming. Given the thinness of the various layers in a laminated LCD substrate lens, it is easy to cut too deep, which results in permanent damage to the laminated LCD substrate lens. Working with a razor can also be dangerous to the worker. Thus, known methods for cutting a PET layer in a laminated liquid crystal film require an extremely high level of precision or result in damaged laminated liquid crystal films.

There is a need for a method of removing a portion of a PET layer in a laminated liquid crystal film by the precision cutting of a tear line in the PET layer. The present invention meets that need.

### SUMMARY OF THE INVENTION

The present invention provides systems and methods that use calibrated lasers to form tear lines in the one or more PET layers of a laminated liquid crystal film. For the purpose of this disclosure a “tear line” refers to the controlled continuous or intermittent, partial or through-cutting of material in a PET layer adhered to a laminated liquid crystal film which creates a weakened area in the PET layer and which then permits a desired portion of the PET layer to be physically removed from the remainder of the PET layer without removing more of the PET layer than desired or otherwise damaging the laminated liquid crystal film. By removing unwanted portions of the PET layer, the laminated liquid crystal film can be shaped for use in eyewear and other applications. The present invention further permits the electrically conductive layers on opposite sides of a liquid crystal layer within a laminated liquid crystal film to be exposed. By exposing the electrically conductive layers, each may then be connected to external electronics and control devices therefor. These control devices and external electronics can then apply the voltage differential(s) that cause the pixels of the liquid crystal layer to transition from a substantially opaque state to a substantially transparent state or vice versa. When a laminated liquid crystal film disposed in a lens in eyewear worn by a user is in a substantially transparent state, sufficient visual information is conveyed to the wearer to permit the wearer to function normally. When the laminated liquid crystal film disposed in a lens is placed in a substantially opaque or translucent state, the visual information provided to the wearer is reduced to nothing or nearly nothing. While alternating between the two states rapidly (although in a timed manner), the wearer must perform tasks using the reduced amount of visual information. This trains the wearer by requiring the wearer to perform complex tasks with limited information. Thus, the functional cutting of the laminated liquid crystal film for this use is a critical aspect in processing the laminated liquid crystal film.

In some embodiments of the present invention, the wavelength of the laser beam used in accordance with the present invention is selected to be a wavelength absorbed by the PET layer to be processed. The absorption of the energy of the laser beam heats the PET material, causing it to vaporize, boil off or melt. The power and wavelength of the laser beam determines the amount of heat delivered to the PET material per unit time. The diameter and cross-sectional shape (circular, square of otherwise) of the laser beam of a known power and wavelength determines the volume of PET material removed per unit time. Then, the time in which the laser transmits laser light to the PET material in a given position on the PET material (generally referred to as the “scan speed”) determines the amount of PET material boiled or melted away. Once it is determined how long the laser beam must be imposed on a specific position on the PET material in order to remove a desired volume (cross-sectional area of the laser beam times the depth of penetration of the laser beam) of PET material from the PET layer, the scan speed can then be determined. The laser is controlled as to energy and time in position to ensure only the PET material is cut into and not the underlying electrically conductive layer or liquid crystal layer.

The invention incorporates the coordination of the position and motion of the laser beam across the PET material.

In accordance with the present invention, the depth of penetration of a laser beam is controlled by calibrating the power of the laser and the scan speed to cause the laser beam to penetrate only to a desired depth into but not through the PET layer. In some embodiments of the present invention, however, it may be desirable to remove the PET material completely through the PET layer but not cut into any layer below the PET layer. The scan speed of the laser determines the dwell time of the laser beam on a portion of a surface of the PET layer of a laminated liquid crystal film, while the power of the laser determines the amount of energy delivered by the laser into the PET layer of the laminated liquid crystal film to be cut per unit time. Accordingly, the amount of energy delivered to a PET layer of a laminated liquid crystal film used in the system and methods in accordance with the present invention is directly dependent on the amount of time a laser delivers energy to a portion of a PET layer in a laminated liquid crystal film (that is, it is a function of scan speed of the laser) and the rate at which energy is delivery by the laser (that is, it is a function of the power of the laser). Equivalent amounts of energy can be delivered to a unit of area of a PET layer of a laminated liquid crystal film. Thus, the same tear line in the PET layer of a laminated liquid crystal film can be made using, for example, a higher power laser for a shorter amount of time or using a lower power laser for a longer amount of time (a longer scan speed). The critical aspect of the enabled invention is the controlled volumetric removal of PET material from the PET layer.

The scan speed of the laser is the rate at which the laser is moved relative to the laminated liquid crystal film being processed in accordance with the present invention. In the present invention, one or both of the laser and the laminated liquid crystal film may be moved relative to the other. A slower scan speed will permit a laser beam to engage a portion of the exposed surface of the PET layer longer, thereby permitting a laser beam having a given power to penetrate further through the PET layer. A faster scan speed will shorten the time during which the laser engages a portion of the surface of the laminated liquid crystal film being cut, thereby limiting the depth to which the laser of a given power may penetrate the PET layer. By adjusting the power and the scan speed of a laser used in accordance with the present invention, the depth of penetration of the laser may be controlled precisely so as to cut through said PET layer to create a tear line in the PET layer that allows the mechanical separation of the unwanted material from the remaining PET layer in the laminated liquid crystal film. At the same time, the laser beam is controlled sufficiently to prevent cutting into and damaging the underlying electrically conductive electric contact layer and/or liquid crystal layer. Operator control over the laser power and scan speed is critical. The penetration of the laser beam into or near the liquid crystal layer may heat the liquid crystal material sufficiently to damage it permanently. Thus, the cutting depth of the laser into the PET layer of the laminated liquid crystal film must be calculated in part based on the temperature gradient at the bottom of the hole cut by the laser beam in the direction of the liquid crystal layer taking into account the highest safe temperature the liquid crystal may tolerate.

In some embodiments of the invention, jigs, mounts or other retaining devices may be provided to retain a laminated liquid crystal film in a position for the application of a laser beam having a predetermined power at a predetermined scan speed. In some embodiments of the invention, a laminated LCD substrate lens may be retained by a jig, mount or other retaining device while a laser source is moved at one or more desired scan speeds along one or more paths selected to correspond to one or more tear lines needed for processing the laminated liquid crystal film. In other embodiments of the invention, the laser source may be fixed in place while the jig, mount or other retaining device is moved at one or more scan speeds along one or more paths selected to correspond to one or more tear lines. In yet additional embodiments, both the laser source and jig, mount or other retaining device may be moved, contemporaneously or serially, relative to one another to produce the desired tear line cut in the laminated liquid crystal film.

A laminated liquid crystal film is commonly affixed, for example using an adhesive, to a resilient polycarbonate substrate to protect the PET layer(s) from damage due to impact or abrasion, to hold the pliable laminated liquid crystal film in a desired shape and position (or both), and/or to provide desired impact resistance. One or more polycarbonate layers may be adhered to a laminated liquid crystal film. For example, a laminated liquid crystal film may be retained between two polycarbonate layers. Or a laminated liquid crystal film may be retained on the inside of a polycarbonate layer in an as-worn position. Or a laminated liquid crystal film may be retained on the outside of a polycarbonate panel in an as-worn position. Processing a laminated liquid crystal film in a accordance with the present invention may be performed before the laminated liquid crystal film is affixed to any polycarbonate layer, but in other embodiments a laminated liquid crystal film may be affixed to a single polycarbonate layer and the exposed portions of the laminated liquid crystal film may be processed using systems and methods in accordance with the present invention (for example, by processing the laminated liquid crystal film from the side not affixed to the polycarbonate material or by processing portions of the laminated liquid crystal film extending beyond the edge of the polycarbonate substrate). In some embodiments, the laminated liquid crystal film applied to a polycarbonate substrate may be trimmed to match the size and shape of the polycarbonate layer using systems and methods in accordance with the present invention and, optionally, further processing may expose the electric contact layers. Due to the physical and chemical properties of polycarbonate materials, however, when a laminated liquid crystal film is processed while affixed to a polycarbonate substrate, systems and methods in accordance with the present invention, the laser beam must be prevented from substantially illuminating the polycarbonate material, as the polycarbonate material may melt, bubble or otherwise adversely react to illumination by the laser beam in a way that damages the polycarbonate material and/or the liquid crystal film to which the polycarbonate material is affixed.

In accordance with the present invention, after tear lines have been created in at least one PET layer of a laminated liquid crystal film, a portion of the PET layer may be mechanically separated from the rest of the liquid crystal film from the tear line to an edge of the laminated liquid crystal film. Such separation may be performed by inserting the edge of a blade into the tear line and using the blade to peel the PET material on a first side of the tear line away from the underlying electrical contact layer and liquid crystal layer, a process that may often (due to the extremely thin dimensions of the electrically conductive layer) remove all or part of the electrical layer between the liquid crystal layer and the portion of the PET layer being removed. In some examples in accordance with the present invention, a tear line may extend from a first edge of a laminated liquid crystal film to a second, and potentially opposing, edge of the laminated liquid crystal film. The PET layer at least partially penetrated by the tear line may be peeled from the tear line to a third edge, thereby exposing any remaining portion of the electrical contact layer underlying the PET layer and the liquid crystal layer. The exposed electrical contact layer and the liquid crystal layer may be removed, for example chemically and/or mechanically, in order to expose the pristine electrical contact layer opposing the liquid crystal layer. Thereafter, an electrical connection to the exposed electrical contact layer may be made.

Systems and methods in accordance with the present invention may be performed on opposing sides of a laminated liquid crystal film to expose electrical contact layers on opposing sides of the liquid crystal layer, with each electrical contact layer so exposed still supported and protected by the remaining PET layer. After processing in accordance with the present invention, along the plane of the liquid crystal film a first portion of the film may comprise only an exposed first electrical contact layer, second portion of the panel may comprise all layers of the laminated liquid crystal film (in order, a first PET layer, a first electrical contact layer, a liquid crystal layer, a second electrical contact layer, and a second PET layer), and a third portion of the panel may comprise an exposed second electrical contact layer and a supporting second PET layer. In such an example, by making a first electrical connection to the first electrical contact layer of the first portion and the second electrical connection to the second electrical contact layer of the third portion, the liquid crystal layer with the second portion may be changed between a substantially transparent state or intermediate state and a substantially opaque or translucent state by modifying the voltage differential applied to the opposing electrical contact layers.

The use of a laser having a wavelength, power, and/or scan speed in accordance with the present invention and as described in some example herein to form tear lines in a PET layer of a laminated liquid crystal film makes processing of those more efficient and cost effective while improving the quality of the processed liquid crystal films. The present invention is not limited to creating any particular type of tear line. For example, a laser may be powered continuously while scanning the exposed surface of a laminated liquid crystal film, thereby forming a continuous line of penetration at least partially through the PET layer. By way of a further example, a laser may be intermittently powered or “pulsed” while scanning the exposed surface of a laminated liquid crystal film, thereby forming a perforated tear line comprising a linear series of short segments of penetration at least partial through the PET layer.

### BRIEF DESCRIPTION OF THE DRAWINGS

FIG. 1 depicts a cross section of an exemplary laminated LCD substrate.

FIG. 2 depicts a cross section of an exemplary laminated LCD substrate after the removal of a portion of one PET layer.

FIG. 3 depicts a cross section of an exemplary laminated LCD substrate after the removal of a portion of a PET layer, an electrical contact layer and a liquid crystal layer.

FIG. 4 depicts an example of a laser scanning over a liquid crystal film.

FIG. 5 depicts a further example of a laser scanning over a liquid crystal film.

FIG. 6 depicts an example of a tear line formed in a pet layer of a liquid crystal film

FIG. 7 depicts a further example of a tear line formed in a PET layer of a liquid crystal film.

FIG. 8 depicts an example of a laminated liquid crystal substrate that has been processed on opposing sides to form a controllable liquid crystal portion.

FIG. 9 depicts an exemplary method in accordance with the present invention.

FIG. 10 depicts an example configuration of vision training eyewear that may be constructed from liquid crystal films processed in accordance with the present invention.

### DETAILED DESCRIPTION OF THE INVENTION

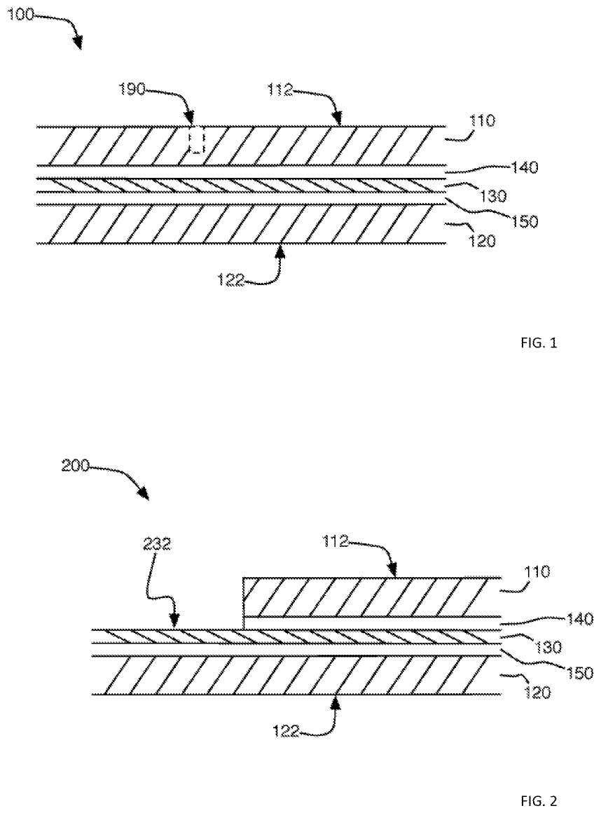

Systems and methods in accordance with the present invention improve the processing of laminated liquid crystal films. Referring to FIG. 1, a laminated liquid crystal film 100 may generally comprise a first polyethylene terephthalate (“PET”) layer 110 and a second PET layer 120. Between the first PET layer 110 and the second PET layer 120 are further disposed, in layers, a first electrical contact layer 140, then a liquid crystal layer 130 and then a second electrical contact layer 150. The electrical contact layers 140 and 150 overlay opposing sides of the liquid crystal layer 130 and are in physical contact with the liquid crystal layer 130. When an appropriate voltage differential is properly applied across the liquid crystal layer 130 using the electrical contact layers 140 and 150, the individual crystals within the liquid crystal layer 130 transition from a first state to a second state. In a liquid crystal, a first state (in the absence of an applied voltage potential) may be either a substantially opaque state or a substantially translucent state. Upon the application of a voltage potential, the liquid crystal transition to a second state. If the first state is substantially opaque, the liquid crystals transition to a second state which is a substantially translucent state. If the first state if substantially translucent, the liquid crystals transition to a second state which is a substantially opaque state. In some embodiments, an intermediate voltage potential may be applied to the liquid crystal layer 130 to obtain an intermediate state between a first state and a second state. The magnitude of the voltage potentially needed to cause a change of state in a liquid crystal typically depends on the properties of the liquid crystal. While the described embodiments herein involve liquid crystal films that transition between a first state and a second state or to an intermediate state, the present invention is not limited to any particular type of liquid crystal.

In order to apply the voltage differential needed to cause the transition of the liquid crystals in a liquid crystal film to transition between states, electrical connections must be made to the two electrical contact layers 140 and 150 disposed on the opposite sides of the liquid crystal layer 130. In laminated liquid crystal films, establishing those electrical connections can be challenging, especially when the laminated liquid crystal film must be cut to a desired shape or configuration. Materials such as PET are often used to enclose the liquid crystal and the electrical contact layers, as described above. The nature of PET presents challenges to forming a portion of a laminated liquid crystal film into a needed shape while likewise exposing the appropriate electrical contact layers at the positions needed to make electrical connections to control the liquid crystal film.

In accordance with the present invention, the selective removal of a portion of a PET layer is facilitated by at least partially penetrating the PET layer using a laser beam to remove, by evaporation or boiling off, a selected portion of the PET material so as to form a tear line. A tear line may extend at least partially through the PET layer and along some length of the PET layer, permitting the PET layer to be mechanically or manually separated along the tear line. Removal of the PET layer along the tear line exposes the underlying layers, such as an electrical contact layer or the liquid crystal layer. Given the delicacy of the electrical contact layer, removal of the PET layer along the tear line often removes the adjacent electrical contact layer adhered to the PET layer, thus exposing the liquid crystal layer. The liquid crystal layer so exposed by the removal of the PET layer at the tear line may thereafter be removed by using a solvent and/or a mechanical process in order to expose the opposing electrical contact layer underlying the liquid crystal layer. In some embodiments of the invention, this process may be repeated on both sides of a laminated liquid crystal film, thereby permitting electrical contact layers on each side of the liquid crystal layer to be exposed without damaging the electrical contact layer and permitting the electrical connections needed to operate the liquid crystal film to be made.

Referring still to FIG. 1, a cross-section of an embodiment of the invention is depicted. Therein, a liquid crystal film 100 is comprised of a first PET layer 110 having an external face 112 and a second PET layer 120 having an external face 122. Disposed between the first PET layer 110 and second PET layer 120 are additional layers, as follows: a first electrical contact layer 140, a liquid crystal layer 130 and a second electrical contact layer 150. A first side of the first electrical layer 140 is adhered to the internal face of the first PET layer 110. A second side of the first electrical layer 140 is adhered to a first side of the liquid crystal layer 130. A second side of the liquid crystal layer 130 is adhered to a first side of the second electrical contact layer 150. A second side of the electrical contact layer is then adhered to the internal face of the second PET layer 120.

The dimensions of each layer above may vary from embodiment to embodiment depending on use. In certain uses, such as for vision training eyewear, the first PET layer 110 and the second PET layer 120 may each be approximately 200 microns think, with the liquid crystal layer 130 approximately 25 microns think. Further, each of the first electrical contact layer 140 and electrical contact layer 150 may be a few hundred nanometers thick, such as approximately 300 nanometers thick. The thicknesses of each of the layers depicted in FIG. 1 should not be considered representative or a limitation of an actual embodiment of a laminated liquid crystal film in the invention 100.

If applied to a polycarbonate layer, the polycarbonate layer may have an appropriate thickness (which need not be constant) for the desired physical and/or optical properties. In some embodiments, a polycarbonate layer may be approximately one to three millimeters thick.

Still referring to FIG. 1, a tear line 190 formed in a laminated liquid crystal film 100 results from the removal of at least part of a first PET layer 110 from the external face 112 using a laser. Tear line 190 may at least partially penetrate the first PET layer 110, for example extending from the external face 112 into approximately halfway or further through the first PET layer 110. While FIG. 1 is a cross-sectional image showing an area of PET removed from the PET layer, a tear line is created by the removal of a specific volume of PET removed from a PET layer. By removing a volume of PET material from the PET layer in a line (whether a continuous line or intermittent line), a weakness is created in the PET layer that permits separation of one part of the PET layer from the other.

Referring now to FIG. 2, an example of a laminated liquid crystal film 200 partially processed in accordance with the present invention is depicted. Having cut a tear line 190 into the first PET layer 110 (as depicted in FIG. 1), a portion of the first PET layer 110 has been peeled away from laminated liquid crystal film 200. In this figure, a portion of the first electrical contact layer 140 was removed with the portion of the first PET layer 110. As a result, a first face 232 of liquid crystal layer 130 has been exposed. The removal of the first electrical layer 140 with the removal of the first PET layer 110 is typical given the extremely thin nature of the first electrical contact layer 140. In the event of incomplete or partial removal of the first electrical layer 140 with the removal of the first PET layer 110, there is little impact on the later processing of the laminated liquid crystal film 200.

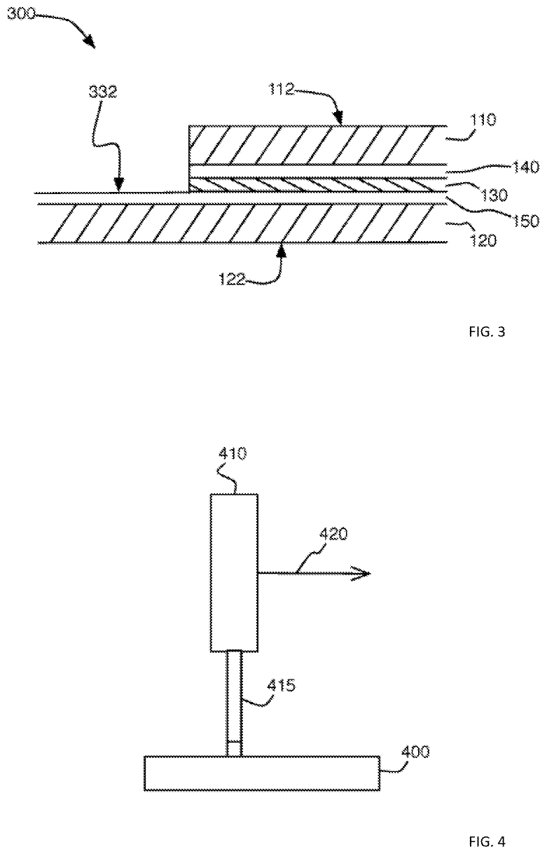

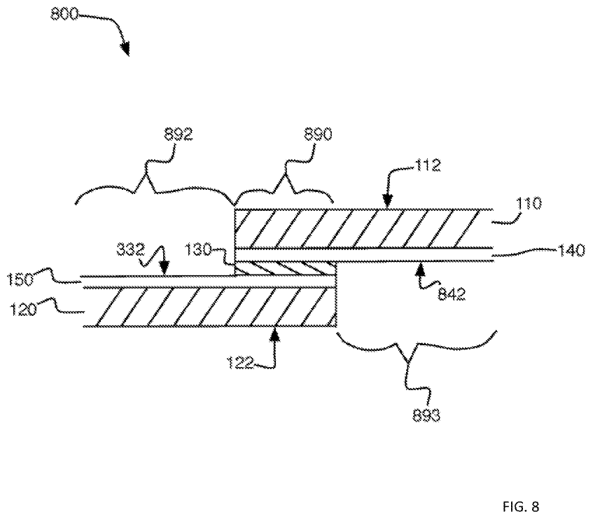

As depicted in FIG. 3, the portion of the liquid crystal layer 130 exposed in the example of FIG. 2 has been removed by known methods to reveal a face 332 of the second electrical contact layer 150. The second PET layer 120 underlying the now-exposed electrical contact layer 150 can provide structural support and resiliency to the portion of the laminated liquid crystal film where only the second PET layer 120 and thin second electrical contact layer 150 remain. The liquid crystal layer 130 may be removed in the portion exposed by the removal of a portion of the first PET layer 110 using alcohol or other solvent, which may be applied using a cotton wipe or other material. By gently applying a solvent to remove a portion of the liquid crystal layer 130, the now exposed second electrical contact layer 150 may be used to form an electrical connection with a voltage source that may be used to control the remaining liquid crystal layer 130. By repeating the process depicted in FIGS. 1-3 from the opposite side of the liquid crystal layer 130, the first electrical contact layer 140 may be exposed. An example of such a processed laminated liquid crystal film is depicted in the example of FIG. 8 and will be described in further detail below.

Referring now to FIG. 4, one example of a laser source 410 that may generate a laser bean 415 having a predetermined power and wavelength when activated is shown. A laser beam 415 is incident upon a surface (such as an external surface 112 of a first PET layer 110 or external surface 122 of second PET layer 120 in the examples of FIG. 1) of a laminated liquid crystal film 400. Laser beam 415 may be moved along the surface of laminated liquid crystal film 400 at a scan speed 420. Scan speed 420 may be selected in conjunction with and relative to the power of the laser source 410 and the wavelength of the generated laser 415 (based at least in part on how that wavelength interacts with a PET material) to control the depth of penetration into the PET layer of liquid crystal film 400. The penetration of the laser beam 415 may extend at least partially through the PET layer to form a tear line in the PET layer.

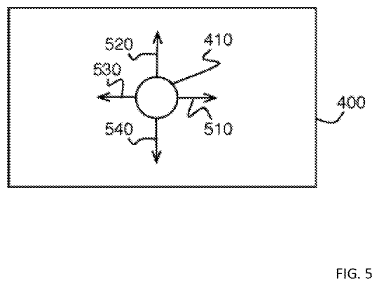

While FIG. 4 depicts the movement of laser source 410 relative to laminated liquid crystal film 400 in only one dimension, as shown in FIG. 5 the laser source 410 may be moved relative to the laminated liquid crystal film along both a positive x-axis 510 and a negative x-axis 530 and along both a positive y-axis 520 and a negative y-axis 540. For clarity, reference to motion of the laser source 410 in Cartesian coordinates is not a limiting feature of the invention. In practice the laser source 410 may be moved along any line or plurality of lines which are describable in Cartesian coordinates, whether straight, curved or complex, or in polar coordinates. Further, while it is described above that the laser source 410 is moved relative to the laminated liquid crystal film 400 at a given scan speed, embodiments of the invention permit the laminated liquid crystal film 400 to be moved relative to a stationary laser source 410. In some embodiments, it is permitted to move each of the laser source 410 and the laminated liquid crystal film 400 relative to each other. Likewise, the description of motion of either the laser source 410 and/or laminated liquid crystal film 400 in a two-dimensional Cartesian coordinate system is not a limitation. In the event of a laminated liquid crystal film 400 with a curvature therein, it may be beneficial to move the laser source 410 and/or the curved laminated liquid crystal film 400 in three dimensions (in Cartesian, spherical, cylindrical or other coordinate systems).

Although the figures depict a macroscopic motion of laser source 410 relative to laminated liquid crystal film 400, beam deflection mechanisms, such as galvanometers or acousto-optical diffraction gratings or the like, with appropriate optics may be used to effect the scan of the laser beam 415 over the laminated liquid crystal film 400. Such beam deflectors may be preferable in some embodiments because of the resulting scan speed and precision and because of the reduced need for macroscopic motion systems.

The mechanisms by which either laser source 410 or laminated liquid crystal film 400 or both are moved are not depicted. A variety of controlled moveable mounts, jigs or other systems to enable motion of each is permitted in different embodiments of the invention so long as the described tear lines are made.

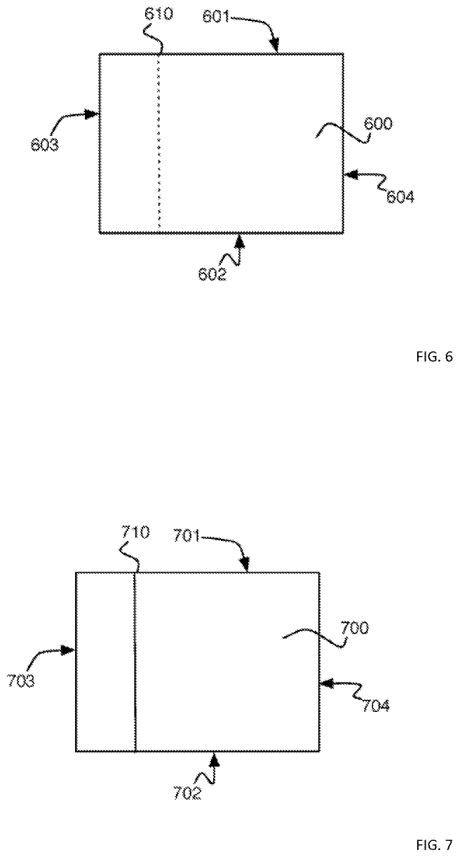

As depicted in FIG. 6 and FIG. 7, systems and methods in accordance with the present invention may be used to create different types of tear lines. For example, a perforated tear line 610 or a continuous tear line 710 may be formed.

As depicted in FIG. 6, a laminated liquid crystal film 600 may have a first edge 601, a second edge 602, a third edge 603, and a fourth edge 604. A laser (not depicted in the example of FIG. 6) may be pulsed as it moves at a scan speed from the first edge 601 to the second edge 602 to form a perforated tear line 610. Perforated tear line 610 may be used to create a removeable section of the PET layer to be peeled away from the laminated liquid crystal film 600. For example, the PET layer between perforated tear line 610 and third edge 603 may be removed or, for another example, the PET layer between perforated tear line 610 and the fourth side 604 may be removed from the laminated liquid crystal film 600.

As depicted in FIG. 7, a laminated liquid crystal film 700 may have a first edge 701, a second edge 702, a third edge 703, and a fourth edge 704. A laser (not depicted in the example of FIG. 7) may be continuously powered as it moves at a scan speed from the first edge 701 to the second edge 702 to form a continuous tear line 710. Continuous tear line 710 may be used to create a removeable section of the PET layer to be peeled away from the laminated liquid crystal film 700. For example, the PET layer between continuous tear line 710 and third edge 703 may be removed or, for another example, the PET layer between continuous tear line 710 and the fourth side 704 may be removed from the laminated liquid crystal film 700.

While depicted in examples with rectangular laminated liquid crystal films having first, second, third and fourth edges in the examples of FIG. 6 and FIG. 7, and further illustrated with exemplary straight tear lines formed perpendicular to those edges, the present invention is not limited to the depicted exemplary geometries. In examples such as the formation of laminated liquid crystal film lenses for vision training eyewear, the laminated liquid crystal films processed in accordance with the present invention may be oval, circular, elliptical or irregular in shape, and the tear line or lines cut by a laser or lasers may be curved, irregular, angled or other suitable shape.

In some examples in accordance with the present invention, prior to forming tear lines as described in examples herein, a laser may be used to cut a piece of laminated liquid crystal film from a “raw” state after initial manufacture to a desired size and shape for processing into a final product. For example, a laser (which may be the same laser used to cut tear lines, but set at a different power and/or scan speed, or a different laser) may be used to cut a piece of shaped laminated liquid crystal film from a larger, raw piece of laminated liquid crystal film. This example might include cutting a lens shaped piece of laminated liquid crystal film slightly larger than the final lens size but in the shape of the desired piece to be used in eyewear. That piece of laminated liquid crystal film may be further processed as described herein to form tear lines that may be used to expose electrical contact layers as needed to operate the liquid crystal layer within the laminated liquid crystal film. If the same laser is used to cut a piece of laminated liquid crystal film in a desired size and shape from a larger piece of laminated liquid crystal film and likewise to form tear lines in the resulting sized and shaped piece of laminated liquid crystal film, the power and/or scan speed and/or continuous or pulsed operation of the laser may be adjusted to obtain different depths of penetration for these different operations.

FIG. 8 depicts an example of a processed laminated liquid crystal film 800 after systems and methods in accordance with the present invention have been used to expose both the second electrical contact layer 150 (as depicted in the example of FIG. 3) and the first electrical contact layer 140 (by repeating the process depicted in FIGS. 1 through 3 from the opposing side of the laminated liquid crystal film 800 to remove the second PET layer 120, second electrical contact layer 150, and liquid crystal layer 130). A first electrical connection may be made to the exposed surface 842 of the first electrical contact layer 140 and a second electrical connection may be made to the exposed surface 332 of the second electrical contact layer 150. The resulting laminated liquid crystal film 800 may have a first portion 890 comprising an unmodified laminated liquid crystal film, i.e., having a first PET layer 110, a second PET layer 120, and liquid crystal layer 130 with a first electrical contact layer 140 and a second electrical contact layer 150. The resulting laminated liquid crystal film 800 may have a first portion 890 comprising an unmodified laminated liquid crystal film, i.e., having a first PET layer 110, a second PET layer 120, and a liquid crystal layer 130 with a first electrical contact layer 140 and a second electrical contact layer 150 that may be connected to a voltage source to apply a voltage differential across the liquid crystal layer 130 within the first portion 890. Meanwhile, a second portion 892 of the laminated liquid crystal film 800 may comprise only the second PET layer 120 and the second electrical contact layer 150 and the third portion 893 of the laminated liquid crystal layer 140. In the example of incorporating laminated liquid crystal film 800 into eyewear, the first portion 890 may be used as a lens for the eyewear, while the second portion 892 and the third portion 893 may be situated within the eyewear frame and used to form the electrical connection needed to control the transition of the liquid crystal layer 130 within the first portion 890 (in this example, a component of a lens worn by a user) between a first state (such as a substantially transparent state) and a second state (such as a substantially opaque or translucent state) or in an intermediate state.

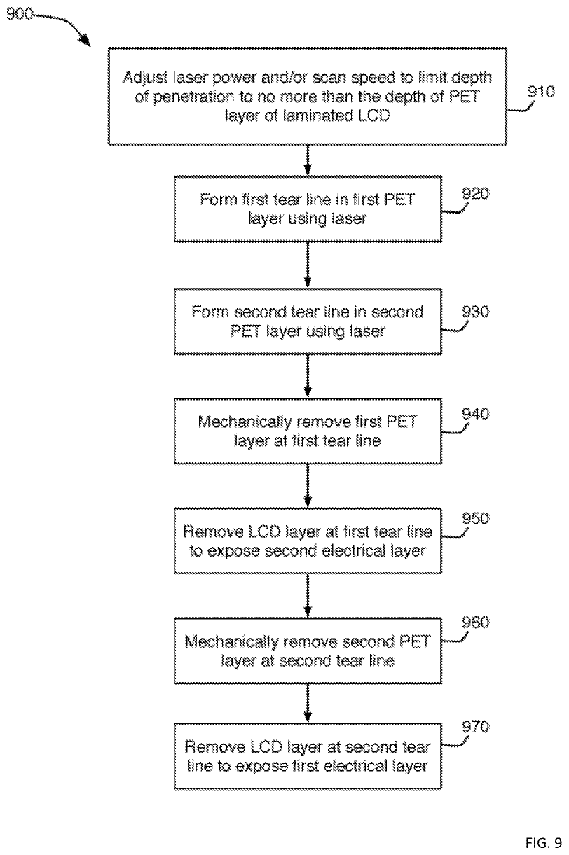

FIG. 9 depicts a flow chart of a method 900 in accordance with the present invention that may be used to process a laminated liquid crystal film in accordance with the present invention. In step 910, the power and/or scan speed of a laser source may be adjusted to control the depth of penetration of the laser through a PET layer of a laminated liquid crystal film. As described in examples herein, the power and/or scan speed may be adjusted based upon the interaction of the wavelength of the laser and the PET material to permit the laser to at least partially penetrate the PET layer without penetrating the liquid crystal layer underlying the PET layer in which a tear line is to be formed. The depth of penetration attained by adjusting the power and/or scan speed of a laser in step 910 may be determined by the type of processing being performed, such as partial penetration if the objective is to expose an electrical contact layer or complete penetration if the objective is to cut the liquid crystal film to a desired shape.

In step 920, a first tear line may be formed in a first PET layer of the laminated liquid crystal film. In step 930, a second tear line may be formed in a second PET layer of the laminated liquid crystal film. Between step 920 and step 930, the liquid crystal film may be reoriented or flipped to permit the laser beam to be incident upon the desired PET surface. Steps 920 and 930 may be performed sequentially or may be performed with iterations of other steps (such as steps 940 and 950, described below) between the performance of step 920 and step 930.

In step 940, the first PET layer may be removed at the first tear line formed in step 920. Step 940 may comprise mechanically peeling the first PET layer from the liquid crystal film. Step 940 may optionally remove a first electrical contact layer from the laminated liquid crystal film.

After step 940, in step 950 the liquid crystal layer exposed in step 940 may be removed. If any portion of the first electrical contact layer remain after step 940, step 950 may remove that portion of the first electrical contact layer as well. Step 950 may include the use of a solvent (such as alcohol) and/or a mechanical process to expose a second electrical contact layer on the opposing side of the liquid crystal layer to be removed in step 950.

In step 960, the second PET layer may be removed at the second tear line formed in step 930. Step 960 may comprise mechanically peeling the second PET layer from the liquid crystal film. Step 960 may optimally remove a second electrical contact layer from the laminated liquid crystal film as well.

In step 970, the liquid crystal layer exposed in step 960 may be removed. If any portion of the second electrical contact layer remains after step 960, step 970 may be used to remove that portion of the second electrical contact layer as needed. Step 970 may use a solvent (such as alcohol) and/or mechanical process to expose a first electrical contact layer on the opposing side of the liquid crystal layer to be removed in step 970.

The steps depicted in the exemplary method 900 of FIG. 9 may be performed in orders other than as shown. For example, a first side of a laminated liquid crystal film may be processed by performing steps 920, 940 and 950 before processing the second side of the laminated liquid crystal film by performing steps 930, 960 and 970. In other examples in accordance with the present invention, only a single side of a laminated liquid crystal film may need to be processed (dependent upon the assembly needs for the ultimate product incorporating the panel), and therefore steps 930, 960 and 970 may be omitted.

In addition to the steps of the exemplary method 900 depicted in the present example, additional steps may be performed. For example, a laser or other device may be used initially to cut a shaped liquid crystal film of at least approximately the desired dimensions and configuration for further processing, in which case the power and/or scan rate of a laser used may differ from the laser used in the exemplary method described herein (although the same laser need not be used if this optional pre-forming step is included). Further, the appropriate electrical connections may be made to enable the remaining liquid crystal layer to be switched between a first state and a second state. The resulting processed laminated liquid crystal film may be assembled and/or installed into a product, such as vision training eyewear, as desired.

Different types of laser cuts may be achieved by moving and/or powering a laser in different patterns. For example, a laser may be moved at a fixed rate while powered at a consistent level, which will result in a uniform depth of penetration of the laser through a PET layer (assuming the material contacted by the laser is uniform). By way of further example, a laser may be moved to a first position, activated at a first power while stationary in that first position for a first period of time, deactivated after the first period of time, and then moved to a second position to be activated for a second period of time at a second power, and so on for multiple positions, powers and periods of time. In such a further example, the time period for which a laser is activated and the power at which the laser is activated may be the same for all positions, thereby creating a uniform depth of penetration at all positions (again, assuming that the material is uniform for all positions), and the positions at which the laser is activated may be uniformly distributed, thereby creating a uniform perforation of at least one PET layer of a liquid crystal film.

The use of perforation cuts with an appropriate duty cycle for the liquid crystal film to be cut may be particularly useful for trimming a liquid crystal film affixed to a polycarbonate layer. For example, a liquid crystal film affixed to a polycarbonate panel may extend beyond the edges of the polycarbonate. Using systems and methods in accordance with the present invention, a perforation may be formed entirely through the liquid crystal film (that is, through a first PET layer, the liquid crystal and electrical contact layers, and then the second PET layer) that permits the physical separation of the portion of the liquid crystal film extending beyond the polycarbonate layer while leaving undamaged electrical contact layer(s) between the locations where the perforations were made, thereby permitting the liquid crystal layer of the liquid crystal film to be electrically controlled from the perimeter. In example for use in vision training eyewear, such a perforation may be used to conform the liquid crystal film to a protective polycarbonate layer and to expose one or both electrical contact layers at one or more perimeter locations, while one or more additional cuts in accordance with the present invention may be made at an interior location (such as the bridge or nose portion of the eyewear) to expose an electrical contact layer to control the portion of a liquid crystal film corresponding to the eye of the individual wearing the eyewear.

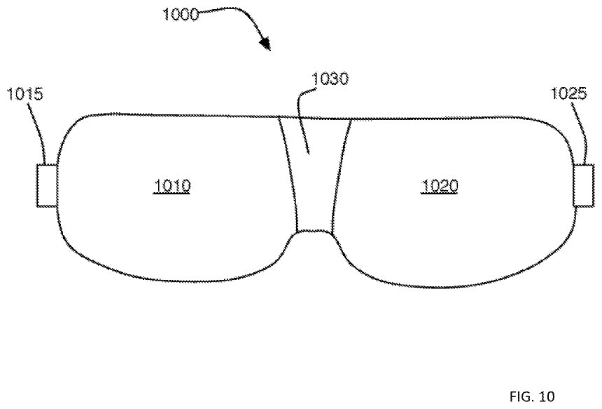

System and methods in accordance with the present invention enable a single liquid crystal film to be processed to provide multiple regions that may each be independently controlled. One way to control multiple regions created in a liquid crystal film in accordance with the present invention is to provide a single common contact for all of the multiple regions and an individual control contact for each of the individual regions. For example, a single liquid crystal film may be processed to create two, three, four or more regions sharing one electrical contact and an additional discrete contact for each of the individual regions. For eyewear, such as depicted in one example in FIG. 10, a first region 1010 may correspond to a user's right eye in an as-worn position while the second region 1020 may correspond to a user's left eye in an as-worn position. A common contact 1030 may be provided within the bridge of such eyewear 1000, while a first discrete contact 1015 for the first region 1010 may be formed at a perimeter location of the first region 1010 and a second discrete contact 1025 for the second region 1020 may be formed at a perimeter location of the second region. While the example of FIG. 10 shows the first discrete contact 1015 and the second discrete contact 1025 at locations corresponding to the right temple and left temple respectively, the location of each such contact along the perimeter of a given region may vary. In different embodiments of the invention, electronic power sources, circuitry, digital processors, control interfaces, and other aspects of eyewear used to power, control and operate the first region 1010 and the second region 1020 to transition between states may optionally be contained in whole or in part within an eyewear frame.

While described in examples herein for use in processing laminated liquid crystal films for use in vision training eyewear, the present invention is not limited to any specific use of the liquid crystal films formed. The laminated liquid crystal films created using systems and methods in accordance with the present invention may be used for any purpose within the scope of the present invention.

The present invention is further not limited to any particular type of laminated liquid crystal film. Laminated liquid crystal films having external layers other than the PET layers described herein may be processed in accordance with the present invention. While the electrical contact layers of exemplary laminated liquid crystal films are described as metalized layers in some embodiments, other types of electrical contact layers may be used in laminated liquid crystal films processed in accordance with the present invention. Further, the present invention is not limited to any particular type of liquid crystal film.

Further, laminated liquid crystal films processed in accordance with the present invention may be assembled into structures having more or fewer layers than those shown in examples herein, as well as different types of layers than depicted in examples herein. In some examples, a single protective polycarbonate layer may be used, while in other examples additional layers, such as may be added to provide additional impact protection and/or light filtering, ay be assembled with a laminated liquid crystal film to be processed in accordance with the present invention.

We claim:

1. An apparatus for the controlled and precise volumetric removal of a plastic material from a laminated liquid crystal film to create a tear line in the plastic material comprising:
a laser suitable to produce a beam of coherent light having a wavelength, intensity, diameter and cross-sectional shape suitable to remove a volume of a plastic layer incorporated as a surface material on a laminated liquid crystal film
a controllable, moveable mount to control and move the laser during the removal of a volume of the plastic layer
a controllable, moveable mount to control and move a laminated liquid crystal film to be cut
a power controller to control the output power of the laser
a motion controller to control the motion of the laser mount relative to the laminated liquid crystal film mount and
sensors suitable to track the removal of a volume of the plastic layer of a laminated liquid crystal film to ensure the desired length, depth and shape of the volume of plastic layer is so removed from the plastic layer of the liquid crystal film.

2. The apparatus of claim 1 in which the motion of the laser is in one dimension.

3. The apparatus of claim 1 in which the motion of the laser is in two dimensions.

4. The apparatus of claim 1 in which the motion of the laser is in three dimensions.

5. The apparatus of claim 1 in which the motion of the laminated liquid crystal film mount is in one dimension.

6. The apparatus of claim 1 in which the motion of the laminated liquid crystal mount is in two dimensions.

7. The apparatus of claim 1 in which the motion of the laminated liquid crystal mount is in three dimensions.

8. A method for cutting a tear line in a PET layer of a laminated liquid crystal film using the steps of:
on a laser source mounted on a controllable, moveable mount setting the power level, diameter of laser beam and shape of the laser beam,
in a control device set the motion of the laser source and the scan speed of the motion of the laser source,
placing a laminated liquid crystal film on a controllable, moveable mount,
in a control device set the motion of the controllable, moveable mount for the laminated liquid crystal film,
using the laser beam of the laser source to remove a volume of plastic from a plastic layer from the laminated liquid crystal film in which the volume of the plastic so removed is determined by the width, length and depth of the plastic so removed.
